(19) United States
(12) Patent Application Publication
(10) Pub. No.: US 2017/0351273 A1
(43) Pub. Date: Dec. 7, 2017

(54) OVERFLOW SYSTEM FOR A HOLDING TANK

(71) Applicant: Claude Chevrette, Laval (CA)

(72) Inventor: Claude Chevrette, Laval (CA)

(21) Appl. No.: 15/613,138

(22) Filed: Jun. 3, 2017

(30) Foreign Application Priority Data
Jun. 4, 2016 (GB) 1609800.6

(51) Int. Cl. G05D 9/02

(52) U.S. Cl. CPC G05D 9/02

(57) ABSTRACT

An overflow system comprising a holding tank having a left side, a right side, and a bottom portion; a water inlet located on the left side proximate to the top portion at a first height; an exhaust port located on the right side proximate to the top portion at a second height; a collection member located proximate to the bottom portion, the collection member consisting of a plurality of parallel pipes, wherein each of the plurality of parallel pipes have a plurality of perforations; a vertical exhaust conduit having a first end and a second end, wherein the first end is coupled to the collection member and the second end is coupled to the exhaust port; a volume of liquid stored in the holding tank, the volume of liquid having a volume of stagnate liquid located in the bottom portion of the holding tank; and a volume of supplied fresh liquid configured to be delivered through the water inlet.

### CROSS-REFERENCE TO RELATED APPLICATIONS

The present application claims priority to United Kingdom Patent Application serial number 1609800.6, filed on Jun. 4, 2016 entitled “Overflow system for a holding tank”, the disclosure of which is hereby incorporated in its entirety at least by reference.

### BACKGROUND OF THE INVENTION

### 1. Field of the Invention

The present invention generally relates to holding tanks, but more particularly to an overflow system for a holding tank.

### 2. Description of Related Art

Water or liquid stored and stagnant for too long in holding tanks tends to be unusable, toxic, and dangerous as it is an environment facilitating bacterial growth. A typical overflow system only takes water from the top, which has freshly arrived, and leaves the long standing stagnant water at the bottom. There are some systems that use pumps to take water from the bottom, but these systems require maintenance. Consequently, there is a need for an overflow system for a holding tank to prevent stagnation while requiring minimal maintenance.

### BRIEF SUMMARY OF THE INVENTION

In one embodiment of the present invention an overflow system is provided comprising a holding tank having a left side, a right side, a bottom portion, and a top portion; a water inlet located on the left side proximate to the top portion at a first height; an exhaust port located on the right side proximate to the top portion at a second height; a collection member located proximate to the bottom portion, the collection member consisting of a plurality of parallel pipes, wherein each of the plurality of parallel pipes have a plurality of perforations; a vertical exhaust conduit having a first end and a second end, wherein the first end is coupled to the collection member and the second end is coupled to the exhaust port; a volume of liquid stored in the holding tank, the volume of liquid having a volume of stagnate liquid located in the bottom portion of the holding tank; and a volume of supplied fresh liquid configured to be delivered through the water inlet such that the volume of stagnate liquid is pushed into the plurality of parallel pipes up the vertical exhaust conduit and out the exhaust port limiting the susceptibility to bacteria growth and contamination in the holding tank.

In one embodiment, the collection member occupies approximately 98% of the bottom portion. In one embodiment, the plurality of perforations is located on a bottom side of each of the plurality of parallel pipes. In another embodiment, the second level of the exhaust port is approximately 4 centimeters lower than the first level of the water inlet. In another embodiment, an expected maximum water level is provided, wherein the expected maximum water level is between the first and second heights. In one embodiment, the exhaust port is located slightly below the expected maximum water level. In one embodiment, the liquid is water. In a particular advantage of the present invention, the system does not include a pump.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is cutaway view of an overflow system for a holding tank according to an embodiment of the present invention.

FIG. 2A is a side view of the overflow system for the holding tank according to an embodiment of the present invention.

FIG. 2B is a detailed view of FIG. 2A showing a side view of a collection member.

FIG. 2C is a detailed bottom view of the collection member of FIG. 2B.

FIGS. 3A-B are perspective views of the holding tank according to an embodiment of the present invention.

FIG. 4 is a side perspective view of the holding tank according to an embodiment of the present invention.

FIG. 5 is a top perspective view of the collection member for the holding tank according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide an overflow system for a holding tank.

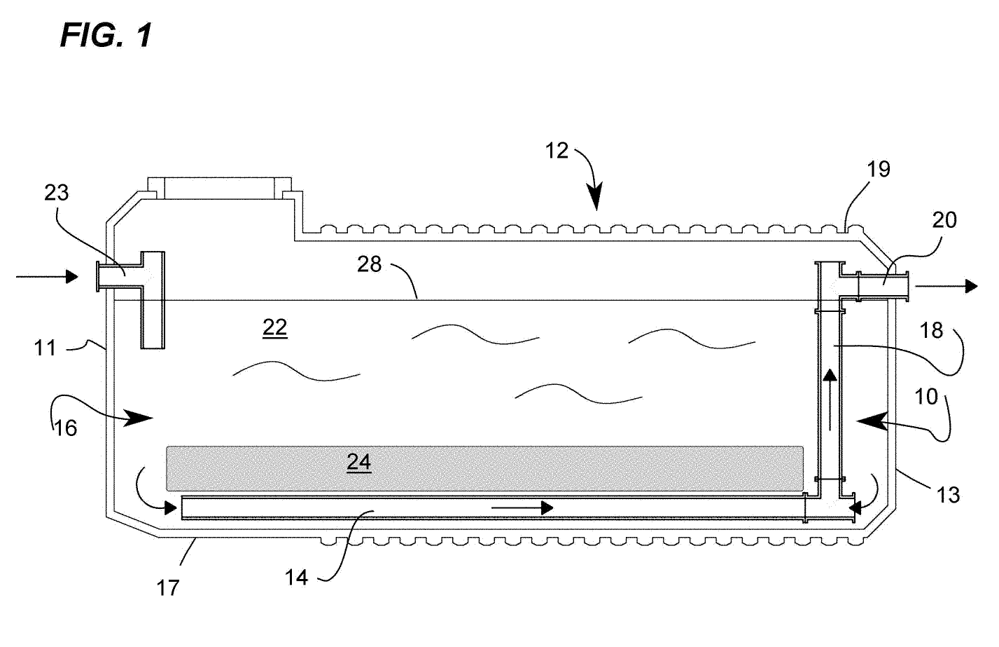

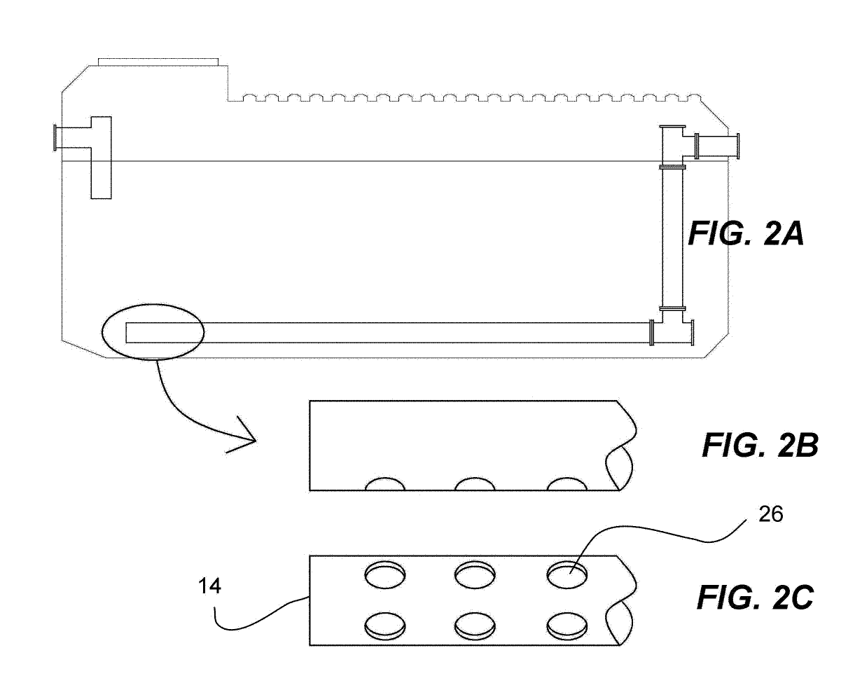

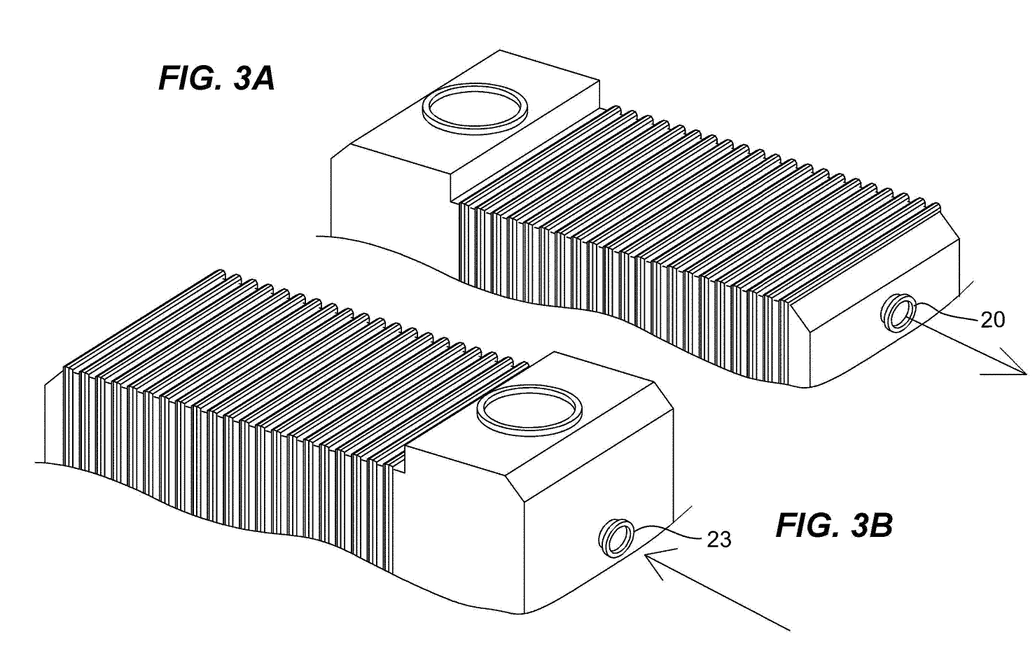

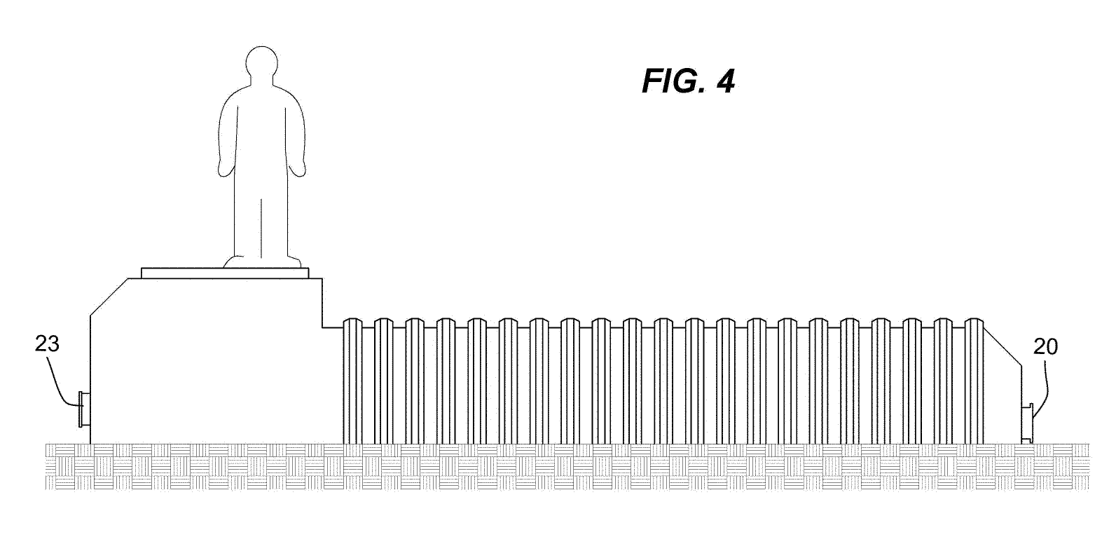

Referring now to FIGS. 1-5, an overflow system 10 comprises a collection member 14 consisting of a plurality of parallel pipes 15. In one embodiment, the plurality of parallel pipes occupies approximately 98% of a bottom portion 16 of a holding tank 12. The collection member is fluidly connected to an exhaust port 20 via a vertical exhaust conduit 18.

During use, supplied fresh water 22 from water inlet 23 pushes stagnate water 24 located in the bottom portion to the collection member up the vertical exhaust conduit and out the exhaust port. This enables the stagnant water to be frequently evacuated, limiting the susceptibility to bacteria growth in the tank and water rendering the water toxic or unusable.

The holding tank comprises a left side 11, a right side 13, a top side 19, and a bottom side 17, wherein the water inlet is located on the left side and the exhaust port is located on the right side. In one embodiment, the collection member is parallel to the bottom side, and as close the bottom side and bottom portion as previously mentioned, ensuring the stagnant water enters the plurality of parallel pipes prior to the supplied fresh water.

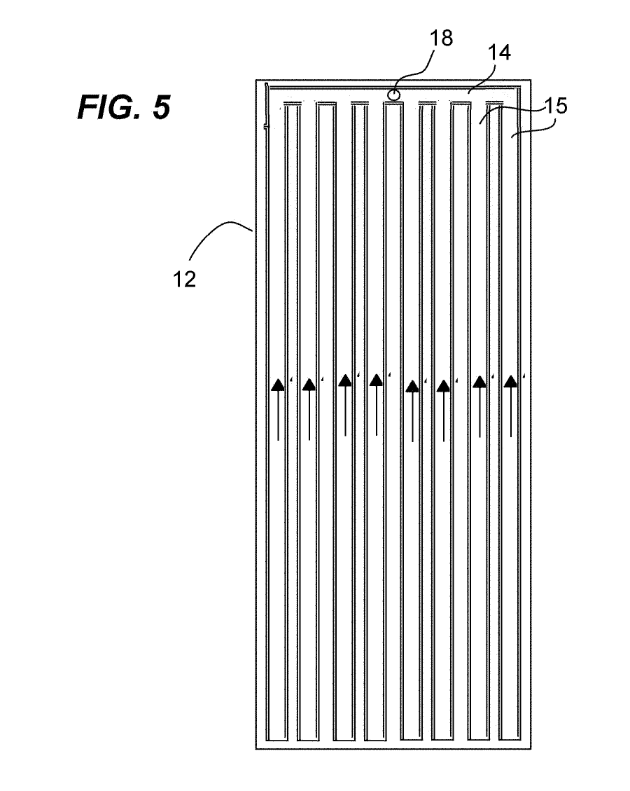

In one embodiment, each of the plurality of parallel pipes comprises a plurality of perforations 26 located on a bottom side 27 of each pipe. The percentage in which the plurality of parallel pipes occupies the bottom portion of the holding tank is best seen in FIG. 5. The occupying percentage is critical as it ensures to move a larger volume of water at the bottom portion of the holding tank than the prior art.

It is a particular advantage of the present invention that the exhaust port is located slightly below an expected maximum water level 28. Assuming the water level is currently at the expected maximum water level, when supplied fresh water is added through the water inlet the total volume of water in the holding tank remains constant, forcing the stagnant water through the plurality of parallel perforated pipes of the collection member, up the vertical exhaust conduit and out the exhaust port. This works on the principle of communicating vessels. In one embodiment, the water inlet is at a first height and the exhaust port is at a second height, wherein the second height is approximately 4 centimeters lower than the first height.

Another particular advantage of the present invention is that the vertical exhaust column isolates and prevents the stagnant water or liquid from mixing with the rest of the holding tank. The renewal of water at the bottom portion of the holding tank ensures the integrity of the stored liquid by preventing the proliferation of bacteria by stagnation while increasing the capacity and volume of the usable available liquid.

A further particular advantage of the present invention is that the system does not require a mechanical pump and is therefore virtually maintenance free.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, the shape of the holding tank may vary and in an alternative embodiment, the shape of the holding tank may be spherical. The same principals of the invention remain and the shape of the collection member and the plurality of pipes may be modified to operate with the spherical holding tank without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object. In addition, reference to “first,” “second,” “third,” and etc. members throughout the disclosure (and in particular, claims) are not used to show a serial or numerical limitation but instead are used to distinguish or identify the various members of the group.

What is claimed is:

1. An overflow system comprising:
a holding tank having a left side, a right side, a bottom portion, and a top portion;
a water inlet located on the left side proximate to the top portion at a first height;
an exhaust port located on the right side proximate to the top portion at a second height;
a collection member located proximate to the bottom portion, the collection member consisting of a plurality of parallel pipes, wherein each of the plurality of parallel pipes have a plurality of perforations;
a vertical exhaust conduit having a first end and a second end, wherein the first end is coupled to the collection member and the second end is coupled to the exhaust port;
a volume of liquid stored in the holding tank, the volume of liquid having a volume of stagnate liquid located in the bottom portion of the holding tank; and
a volume of supplied fresh liquid configured to be delivered through the water inlet such that the volume of stagnate liquid is pushed into the plurality of parallel pipes up the vertical exhaust conduit and out the exhaust port limiting the susceptibility to bacteria growth and contamination in the holding tank.

2. The overflow system of claim 1, wherein the collection member occupies approximately 98% of the bottom portion.

3. The overflow system of claim 1, wherein the plurality of perforations is located on a bottom side of each of the plurality of parallel pipes.

4. The overflow system of claim 1, wherein the second level of the exhaust port is approximately 4 centimeters lower than the first level of the water inlet.

5. The overflow system of claim 4, further comprising an expected maximum water level, wherein the expected maximum water level is between the first and second heights.

6. The overflow system of claim 5, wherein the exhaust port is located slightly below the expected maximum water level.

7. The overflow system of claim 1, wherein the liquid is water.

8. The overflow system of claim 1, wherein the system does not include a pump.
